(19) United States
(12) Patent Application Publication
(10) Pub. No.: US 2005/0023196 A1
(43) Pub. Date: Feb. 3, 2005

(54) Y strainer with automatic flush filter

(75) Inventor: Yi-Lang Ku, Miao-Li-Hsien (CN)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 10/629,385

(22) Filed: Jul. 29, 2003

(51) Int. Cl. B01D 35/147

(52) U.S. Cl. 210/90; 210/104; 210/497.3; 210/446

(57) ABSTRACT

A liquid Y-strainer having a filter which can be automatically flushed without system shutdown or easily and quickly removed for cleaning or replacement, as needed. The Y-strainer includes a conduit which is connected to a liquid flow system such as a drain system for wet scrubbers or water cooling systems used in the fabrication of semiconductors, for example. A typically conical filter housing extends from the conduit and contains a typically removable, conical filter for screening particles from the liquid conveyed through the conduit.

### FIELD OF THE INVENTION

The present invention generally relates to Y strainers used for filtering particles from effluent in a wafer scrubber or water cooling tower used in semiconductor fabrication facilities. More particularly, the present invention relates to a Y strainer having a filter which can be easily and quickly flushed or removed from the strainer for cleaning and replacement, as needed.

### BACKGROUND OF THE INVENTION

In the fabrication process for semiconductor devices, numerous fabrication steps, as many as several hundred, must be executed on a silicon wafer in order to complete integrated circuits on the wafer. Since the processing of silicon wafers requires extreme cleanliness in the processing environment to minimize the presence of contaminating particles or films, the surface of the silicon wafer is frequently cleaned after each processing step. For instance, the wafer surface is cleaned after the deposition of a surface coating layer such as oxide or after the formation of a circuit by a processing step such as etching. A frequently-used method for cleaning the wafer surface is a wet scrubbing method.

In cleaning a wafer surface by a wet scrubbing method, a wafer is rotated at a high speed, i.e., at least about 200 RPM and preferably, about 1,000 RPM, simultaneously with a jet of high-pressure deionized water sprayed on top. The water jet is normally sprayed at a pressure of about 2,000-3,000 psi. The water movement on top of the wafer surface displaces any contaminating particles that are lodged on the wafer surface.

A typical conventional wet scrubber for semiconductor wafers is generally indicated by reference numeral 2 in the schematic of FIG. 1 and includes a chamber 4 including an inlet 6 through which a wafer (not illustrated) is placed in the chamber 4 and an outlet 8 through which the wafer is removed from the chamber 4. Multiple spray nozzles 10 are provided in the top of the chamber 4 for spraying water 12 onto the wafer inside the chamber 4. A viewing window 14 may be provided in the chamber 4 for viewing the wafer therein. The spray water 12 is drained from a collecting receptacle 16 at the bottom of the chamber 4 through a water drain line 18, which distributes the water through a Y-strainer 20 including a typically cylindrical filter 22, as illustrated in FIG. 3. The filter 22 of the Y-strainer 20 removes particles 31 from the water, and a water return line 24 re-distributes the filtered water ultimately back to the spray nozzles 10. Pressure monitors 21 may be provided in the water drain line 18 and water return line 24 on respective sides of the Y-strainer 20 to monitor and compare the pressure of water flowing through the water drain line 18 and water return line 24. When the difference in water pressures in the water drain line 18 and water return line 24 as measured by the water pressure monitors 21 exceeds a predetermined value, such a pressure differential indicates that the filter 22 in the Y-strainer 20 may require cleaning or replacement due to excessive accumulation of particles in the filter 22.

As further illustrated in FIG. 3, the filter 22 of the conventional Y-strainer 20 is contained inside the generally cylindrical filter housing 30, which angles from an elongated conduit 26 fitted with end flanges 28 for attachment of the Y-strainer 20 to the water drain line 18 and water return line 24, respectively. The cylindrical filter 22 extends into the conduit 26 and catches the water flowing therethrough, such that particles 31 in the water are trapped and accumulate in the filter 22. A cap 32 on the filter housing 30 is periodically removed to facilitate removing the particles 31 from the filter 22.

In another application, illustrated in FIG. 2, the conventional Y-strainer 20 is used to filter water in a water cooling system 34 including a cooling tower 36, typically having a pair of conduits 38 for conveying processing water to a heat sink 40. A fan 42, powered by an electric motor 44, draws cool air across the conduits 38 to dissipate heat from the water flowing therethrough. A water drain line 46 drains the water from the heat sink 40 and distributes the partially-cooled water through the filter 20, wherein the Y-strainer 20 removes particles 31 from the water before the water is distributed through a heat exchanger 50 which further cools the water. Finally, a water return line 48 circulates the water back to the cooling tower 36 for a subsequent cooling cycle. Pressure monitors 47 may be provided on respective sides of the Y-strainer 20 to monitor and compare the pressure of water flowing through the water drain line 46 and water return line 48, respectively, and thus indicate the need for cleaning or replacing the filter 22 or Y-strainer 20.

The conventional Y-strainer 20 having the conventional filter 22 suffers from several disadvantages. The filter 22 is typically fixedly mounted inside the strainer housing 30, and this renders difficult the cleaning process for complete removal of the particles 31 from the filter 22. Consequently, particles 31 remaining in the filter 22 tend to reduce the particle-removing efficiency of the filter 22. This contributes to an increase in the number of contaminating particles 31 in the water re-distributed back to the spray nozzles 10 in the wet scrubber 2, as well as reduces the efficiency of the heat exchanger 50 in the water cooling system 34. Furthermore, the wet scrubber 2, water cooling system 34 or other system of which the Y-strainer 20 is a part must be shut down for cleaning of the filter 22. Because the filter 22 must typically be cleaned often, the shutdown rate for the wet scrubber 2 or the water cooling system 34 is high, and this interrupts semiconductor production and significalty increases production costs.

Accordingly, a Y-strainer is needed having a filter which can be automatically flushed without requiring shutdown of the system of which the Y-strainer is a part and which filter can be easily removed from the Y-strainer for complete cleaning or for replacement thereof as needed.

An object of the present invention is to provide a new and improved Y-strainer having a filter which can be flushed as needed to remove particles therefrom.

Another object of the present invention is to provide a new and improved Y-strainer having a filter which can be quickly and easily removed for cleaning or replacement purposes.

Still another object of the present invention is to provide a Y-strainer having a filter which may be conical in shape to facilitate quick and easy removal from and replacement in a correspondingly-shaped filter housing on the Y-strainer.

Yet another object of the present invention is to provide a Y-strainer having a filter which can be flushed to remove particles therefrom without terminating operation of a wet scrubber, water cooling system or other system of which the Y-strainer is a part.

A still further object of the present invention is to provide a Y-strainer which increases production and reduces production costs associated with filtering particles from water in the system.

### SUMMARY OF THE INVENTION

According to these and other objects and advantages, the present invention comprises a liquid Y-strainer having a filter which can be automatically flushed without system shutdown or easily and quickly removed for cleaning or replacement, as needed. The Y-strainer includes a conduit which is connected to a liquid flow system such as a drain system for wet scrubbers or water cooling systems used in the fabrication of semiconductors, for example. A typically conical filter housing extends from the conduit and contains a typically removable, conical filter for screening particles from the liquid conveyed through the conduit. A drain valve is provided on the end of the filter housing for periodically draining particles from the filter, as needed.

The present invention further comprises a wet scrubber having a water drain line which is fitted with the Y-strainer of the present invention. Liquid pressure monitors may be provided on respective sides of the Y-strainer to monitor the pressure of the liquid flowing into and out of the Y-strainer. An increased pressure of the liquid flowing into the Y-strainer relative to the pressure of the liquid flowing out of the Y-strainer may indicate excessive accumulation of particles in the filter of the Y-strainer and thus, the need for flushing the particles from the filter. A power source and controller may be connected to the pressure monitors and the Y-strainer for automatically controlling the filter flushing operation responsive to the increased liquid pressure.

The present invention further comprises a water cooling system having a water drain line which is fitted with the Y-strainer of the present invention. Liquid pressure monitors may be provided on respective sides of the Y-strainer to monitor the pressure of the liquid flowing into and out of the Y-strainer, and thus, indicate the need for flushing the particles from the filter in the Y-strainer. A power source and controller may be connected to the pressure monitors and the Y-strainer for automatically controlling the flushing operation responsive to the increased liquid pressure.

### BRIEF DESCRIPTION OF THE DRAWINGS

The present invention will now be described, by way of example, with reference to the accompanying drawings, wherein:

FIG. 1 is a schematic view illustrating a typical conventional wet scrubber for semiconductor wafers;

FIG. 2 is a schematic view illustrating a typical conventional water cooling system for cooling process water in a semiconductor fabrication facility;

FIG. 3 illustrates a conventional Y-strainer used in filtering water in a wet scrubber or water cooling system;

FIG. 4 illustrates an illustrative embodiment of the Y-strainer of the present invention;

FIG. 5 is a rear view of the filter component of the Y strainer of the present invention;

FIG. 6 is a side view of the filter;

FIG. 7 illustrates the Y-strainer with the filter, cap and drain valve components removed from the Y-strainer;

FIG. 8 is a sectional view of an illustrative drain valve of the Y-strainer of the present invention;

FIG. 9 is a bottom view of an illustrative drain valve of the Y-strainer of the present invention;

FIG. 10 is a schematic view illustrating a wet scrubber in implementation of the present invention;

FIG. 11 is a schematic view illustrating a water cooling system in implementation of the present invention;

FIG. 12 illustrates filtering operation of the Y-strainer of the present invention during normal system operation; and

FIG. 13 illustrates the filter-flushing function of the Y-strainer of the present invention, during system operation.

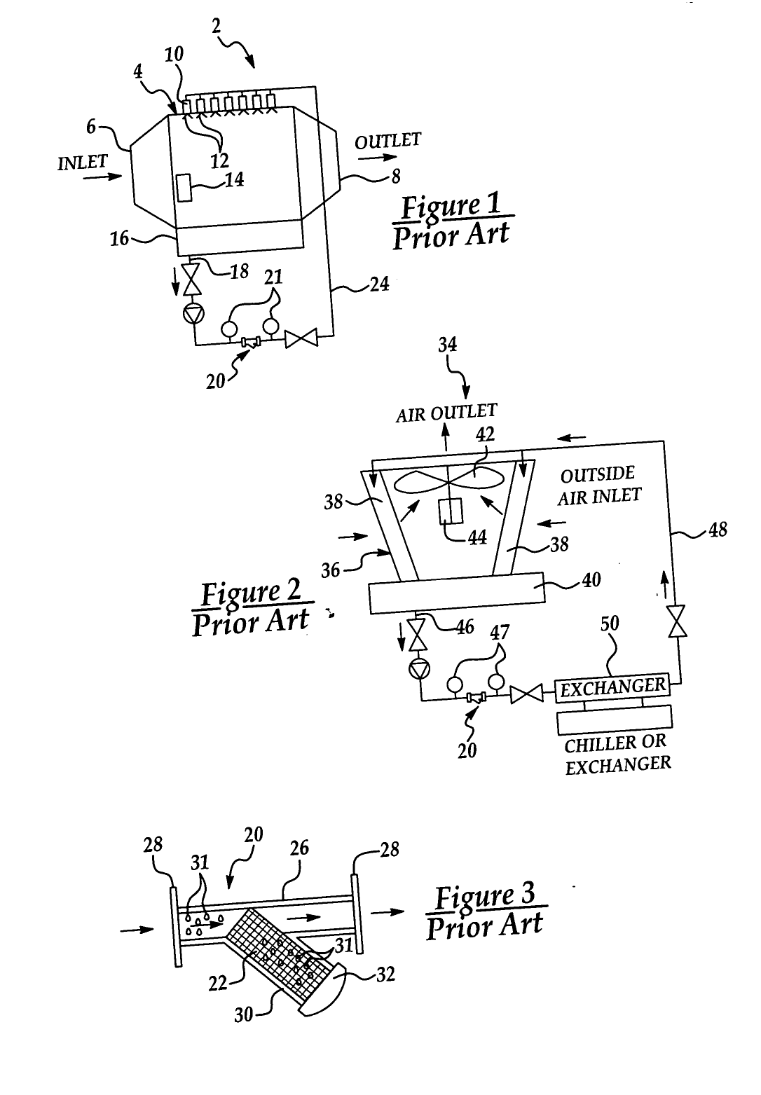

### DESCRIPTION OF THE PREFERRED EMBODIMENTS

The present invention has particularly beneficial utility in filtering particles from water in wet scrubbers and water cooling systems used in semiconductor fabrication processes. However, the invention is not so limited in application, and while references may be made to such wet scrubbers and water cooling systems, the invention is more generally applicable to filtering liquids in a variety of industrial and product applications.

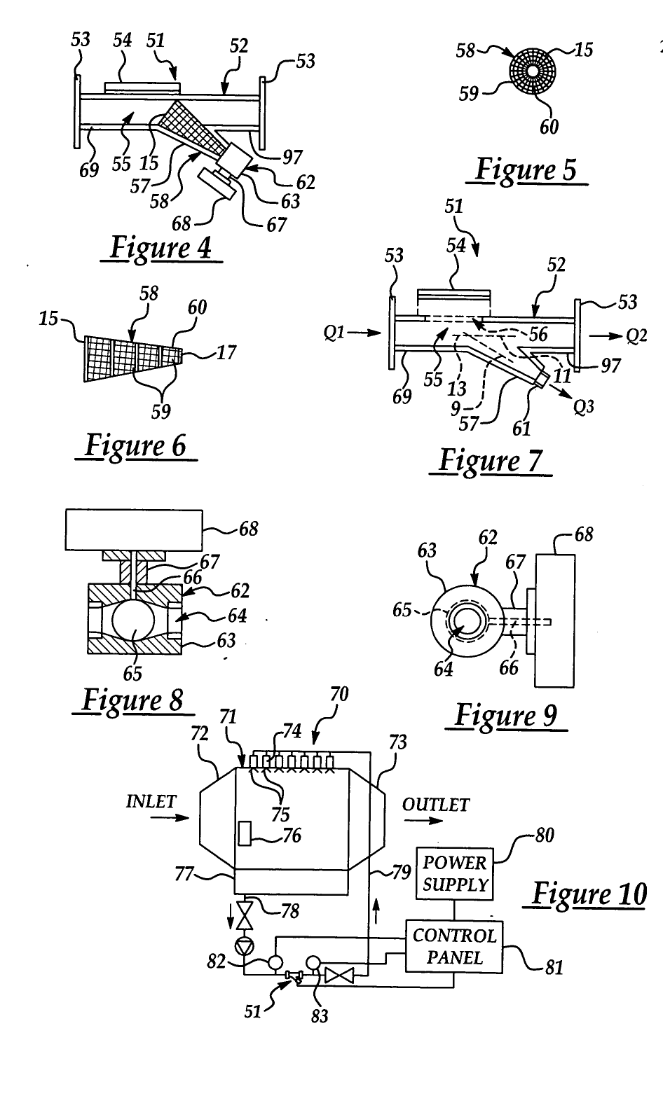

Referring to FIGS. 4-9, a Y-strainer of the present invention is generally indicated by reference numeral 51 and includes an elongated conduit 52, which may be fitted with end flanges 53 on respective ends thereof for attaching the Y-strainer 51 to a water drain line or pipe and/or a water return line or pipe, as hereinafter described. Alternatively, the Y-strainer 51 may be formed integrally with or otherwise attached to the water drain line or pipe and/or the water return line or pipe. A filter housing 57, which may be conical in shape, as illustrated, angles downwardly from the conduit 52 and communicates with a conduit interior 55 of the conduit 52. The filter housing 57 defines a liquid intake arm 69 in the conduit 52 on one side of the filter housing 57 and a liquid outlet arm 97 in the conduit 52 on the other side of the filter housing 57. As illustrated in FIG. 7, the longitudinal axis 11 of the filter housing 57 is disposed at an obtuse angle, typically from about 95 degrees to about 175 degrees, with respect to the longitudinal axis 13 of the liquid intake arm 69 and at an acute angle, typically about 5 degrees to about 85 degrees, with respect to the longitudinal axis 11 of the liquid outlet arm 97. The filter housing 57 may be terminated by a valve mount nipple 61.

A filter 58, which may be conical in shape, as illustrated, is removably fitted in the filter housing 57. The filter 58 includes a frame 59, on which is mounted a mesh 60 having mesh openings of selected size. When the filter 58 is fitted in the filter housing 57, the wide rear end 15 of the filter 58 extends into the conduit interior 55, as illustrated in FIG. 4, and engages the curved interior surface of the conduit 52. The narrow or tapered front end 17 of the filter 58 is disposed adjacent to the valve mount nipple 61. As further illustrated in FIG. 7, a cap opening 56 is provided in the conduit 52 opposite the filter housing 57, and a cap 54 removably engages the exterior surface of the conduit 52, as illustrated, or is hingedly attached to the conduit 52 to removably close the cap opening 56. Accordingly, by removing the cap 54 from the conduit 52, the filter 58 may be easily removed from and replaced in the filter housing 57 through the cap opening 56 for washing or replacement purposes, as hereinafter further described.

The valve housing 63 of a drain valve 62 is mounted on the valve mount nipple 61 at the tapered end of the filter housing 57. The drain valve 62 further includes a valve actuator 68 connected to the valve housing 63 typically through a connector 67. As illustrated in FIG. 8, a drain passage 64 extends laterally through the valve housing 63, and a valve disk 65, provided on one end of an actuator arm 66, is normally disposed in the drain passage 64 to prevent flow of fluid through the drain passage 64. The opposite end of the actuator arm 66 is connected to the valve actuator 68. Accordingly, via the actuator arm 66, the valve actuator 68 may be operated to retract the valve disc 65 from the drain passage 64 to permit flow of liquid therethrough or extend the valve disc into the drain passage 64 to restrict flow of liquid therethrough. The valve actuator 68 may be an electric solenoid actuator, a pneumatic actuator or an oil pressure (hydraulic) actuator. It is understood that the drain valve 62 having the specific design heretofore described with respect to FIGS. 8 and 9 serves as only one example of a valve which is suitable for draining particles from the Y-strainer 51. Accordingly, other types of valves having any suitable alternative designs may be used instead of the drain valve 62 having the design heretofore described.

Referring next to FIG. 10, in application the Y-strainer 51 of the present invention may be provided in a water drain line 78 of a wet scrubber 70 including a chamber 71 having an inlet 72 and an outlet 73 for a semiconductor water (not illustrated); multiple spray nozzles 74 for spraying water 75 into the chamber 71; and a viewing window 76. The spray water 75 is drained from a collecting receptacle 77 at the bottom of the chamber 71 through the water drain line 78, which distributes the water 75 through the Y-strainer 51 of the present invention. As the water flows through the conduit 52 of the Y-strainer 51, as indicated by the arrows in FIG. 12, the filter 58 catches and traps particles 100 flowing with the water into the liquid intake arm 69 of the conduit 52 such that the water flowing from the conduit 52 through the liquid outlet arm 97 is essentially particle-free. A water return line 79 typically re-distributes the filtered water from the Y-strainer 51 ultimately back to the spray nozzles 74. Over time, the particles 100 accumulate in the filter 58, at which time the filter 58 must be flushed to remove the particles 100 therefrom. This is accomplished by opening the drain valve 62 by operation of the valve actuator 68 while continuing circulation of the water through the water drain line 78, Y-strainer 51 and water return line 79, respectively, of the wet scrubber 70. Accordingly, as illustrated in FIG. 13, the water flows with the particles 100 previously lodged in the filter 58 from the open drain valve 62, and the flush water 99 and particles 100 therein may be collected in a receptacle 98 or distributed through a hose (not illustrated) attached to the drain valve 62 and deposited into a suitable receptacle 98. Flow of flush water 75 and particles 100 from the drain valve 62 is continued until the particles 100 have been essentially removed from the filter 58, at which time the drain valve 62 is closed. It will be appreciated by those skilled in the art that the drain valve 62 may be operated to flush the particles 100 from the filter 58 during continuous operation of the wet scrubber 70, without the need to terminate flow of water through the water drain line 78 and water return line 79. This is apparent from a consideration of FIG. 7, wherein the outlet water quantity “Q2” is the same as the inlet water quantity “Q1” during normal operation of the wet scrubber 70 and filtering operation of the Y-strainer 51. Upon opening of the drain valve 62 to flush the filter 58, the drain water quantity “Q3” flowing from the filter housing 57 is smaller than the outlet water quantity “Q2”, and consequently, the filter-flushing operation of the Y-strainer 51 does not affect normal operation of the wet scrubber 70.

As further illustrated in FIG. 10, an intake pressure monitor 82 may be provided in the water drain line 78 on the intake side of the Y-strainer 51, and an outlet pressure monitor 83 may be provided in the water return line 79 on the outlet side of the Y-strainer 51, to monitor the pressure of water on the respective sides of the Y-strainer 51. Accordingly, in the event that the water pressure as measured by the intake pressure monitor 82 exceeds the water pressure as measured by the outlet pressure monitor 83 by a predetermined value, typically at least about 5 psi, for example, this water pressure discrepancy indicates excessive accumulation of particles 100 in the filter 58, and thus, a need to flush the filter 58 of the Y-strainer 51. A power supply 80 and a controller 81 may be connected to the drain valve 62 of the Y-strainer 51, the intake pressure monitor 82 and the outlet pressure monitor 83 to facilitate automatic flushing of the filter 58 when the water pressure as measured by the intake pressure monitor 82 exceeds the water pressure as measured by the output pressure monitor 83 by the predetermined value. In the event that the filter 58 is broken due to prolonged operation of the Y-strainer 51, for example, the filter 58 may be easily replaced by removing the cap 54 from the conduit 52 to expose the cap opening 56, as illustrated in FIG. 7; removing the broken filter 58 from the filter housing 57 and conduit 52 through the cap opening 56; fitting a replacement filter 58 into the filter housing 57 through the cap opening 56; and replacing the cap 54 on the conduit 52 to close the cap opening 56.

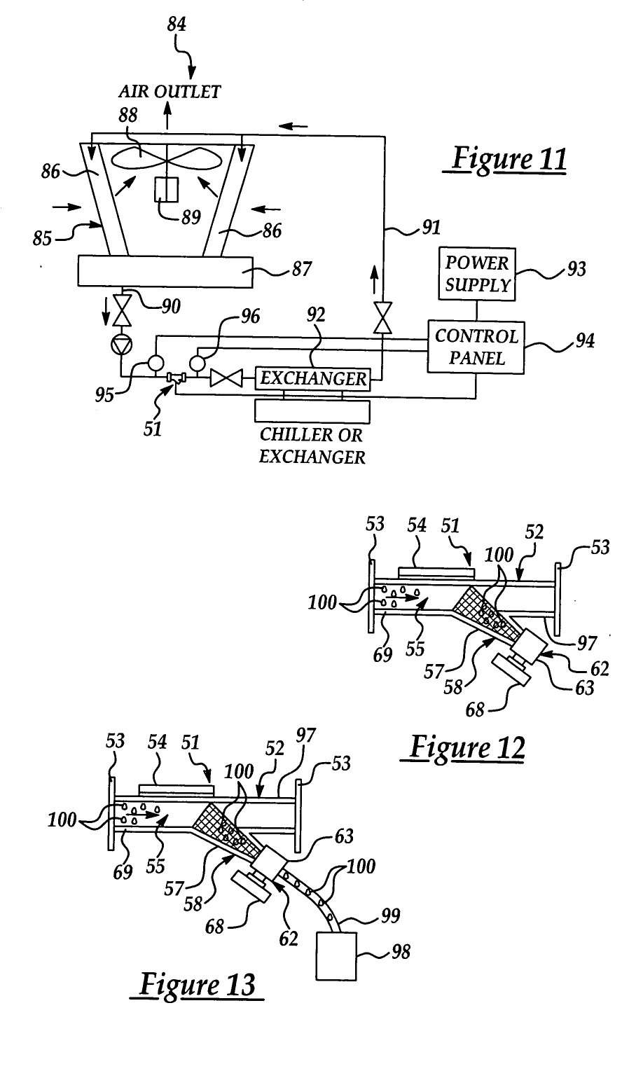

Referring next to FIG. 11, in another application the Y-strainer 51 of the present invention may be provided in a water drain line 90 of a water cooling system 84 used for cooling hot process water in a semiconductor fabrication facility, for example. Such a water cooling system 84 may include a cooling tower 85, typically having a pair of conduits 86 for conveying processing water to a heat sink 87; a fan 88, powered by an electric motor 89; and the water drain line 90, which drains the water from the heat sink 87 and distributes the partially-cooled water through the Y-strainer 51 of the present invention. The filter 58 of the Y-strainer 51 removes particles 100 from the water before the water is distributed through a heat exchanger 92 which further cools the water, in the manner heretofore described with respect to FIG. 12. Finally, a water return line 91 may circulate the water back to the cooling tower 85 for a subsequent cooling cycle. After particles 100 removed from the water flowing through the Y-strainer 51 have accumulated in the filter 58 after prolonged operation of the water cooling system 84, the filter 58 may be flushed to remove the particles 100 therefrom by operation of the drain valve 62, in the same manner as heretofore described with respect to FIG. 13. The filter-flushing operation can be accomplished during continuous operation of the water cooling system 84. An intake pressure monitor 95 and an outlet pressure monitor 96 may be provided on the intake and outlet sides, respectively, of the Y-strainer 20 to monitor the pressure of water flowing through the water drain line 90 and water return line 91, respectively, and indicate the need for cleaning or replacing the filter 58 in the event that the water pressure as measured by the intake pressure monitor 95 exceeds that measured by the outlet pressure monitor 96 by a predetermined value, typically about 5 psi, for example. A power supply 93 and a controller 94 may be connected to the drain valve 62 of the Y-strainer 51, the intake pressure monitor 95 and the outlet pressure monitor 96 to facilitate automatic flushing of the filter 58 when the water pressure as measured by the intake pressure monitor 95 exceeds the water pressure as measured by the outlet pressure monitor 96 by the predetermined value. In the event that the filter 58 is broken due to prolonged operation of the Y-strainer 51, for example, the filter 58 may be easily replaced by removing the cap 54 from the conduit 52 to expose the cap opening 56, as illustrated in FIG. 7; removing the broken filter 58 from the filter housing 57 and conduit 52 through the cap opening 56; fitting a replacement filter 58 into the filter housing 57 through the cap opening 56; and replacing the cap 54 on the conduit 52 to close the cap opening 56, as heretofore described.

While the preferred embodiments of the invention have been described above, it will be recognized and understood that various modifications can be made in the invention and the appended claims are intended to cover all such modifications which may fall within the spirit and scope of the invention.

Having described our invention with the particularity set forth above, we claim:

1. A strainer comprising:
an elongated conduit;
a filter housing extending from said conduit in angular relationship to a longitudinal axis of said conduit;
a filter contained in said filter housing; and
a drain valve provided on said filter housing.

2. The strainer of claim 1 wherein said filter is removably contained in said filter housing.

3. The strainer of claim 1 wherein said filter housing and said filter have a substantially conical configuration.

4. The strainer of claim 3 wherein said filter is removably contained in said filter housing.

5. The strainer of claim 2 further comprising a cap opening provided in said conduit for removing and replacing said filter in said filter housing and a cap engaging said conduit for reversibly closing said cap opening.

6. The strainer of claim 5 wherein said filter housing and said filter have a substantially conical configuration.

7. The strainer of claim 1 further comprising a pair of end flanges provided at respective ends of said conduit.

8. The strainer of claim 7 wherein said filter housing and said filter have a substantially conical configuration, wherein said filter is removably contained in said filter housing and further comprising a cap opening provided in said conduit for removing and replacing said filter in said filter housing and a cap engaging said conduit for reversibly closing said cap opening.

9. A wet scrubber comprising:
a chamber;
a fluid drain line provided in fluid communication with said chamber;
an elongated conduit having a first end provided in fluid communication with said fluid drain line and a second end spaced from said first end;
a fluid return line provided in fluid communication with said second end of said conduit;
a filter housing extending from said conduit in angular relationship to a longitudinal axis of said conduit;
a filter provided in said filter housing; and
a drain valve provided on said filter housing.

10. The wet scrubber of claim 9 wherein said filter is removably contained in said filter housing.

11. The wet scrubber of claim 10 further comprising a cap opening provided in said conduit for removing and replacing said filter in said filter housing and a cap removably engaging said conduit for reversibly closing said cap opening.

12. The wet scrubber of claim 11 wherein said filter housing and said filter have a substantially conical configuration.

13. The wet scrubber of claim 9 further comprising a first pressure monitor provided in said fluid drain line for measuring a first fluid pressure, a second pressure monitor provided in said fluid return line for measuring a second fluid pressure and a controller connected to said first pressure monitor, said second pressure monitor and said drain valve for operating said drain valve when said first fluid pressure measured by said first pressure monitor exceeds said second fluid pressure measured by said second pressure monitor by a predetermined value.

14. The wet scrubber of claim 13 wherein said predetermined value is at least about 5 psi.

15. A cooling system comprising:
a cooling tower;
a water drain line provided in fluid communication with said cooling tower;
an elongated conduit having a first end provided in fluid communication with said water drain line and a second end spaced from said first end;
a water return line provided in fluid communication with said second end of said conduit;
a filter housing extending from said conduit in angular relationship to a longitudinal axis of said conduit;
a filter provided in said filter housing; and
a drain valve provided on said filter housing.

16. The cooling system of claim 15 wherein said filter is removably contained in said filter housing.

17. The cooling system of claim 16 further comprising a cap opening provided in said conduit for removing and replacing said filter in said filter housing and a cap removably engaging said conduit for reversibly closing said cap opening.

18. The cooling system of claim 17 wherein said filter housing and said filter have a substantially conical configuration.

19. The cooling system of claim 15 further comprising a first pressure monitor provided in said water drain line for measuring a first water pressure, a second pressure monitor provided in said water return line for measuring a second water pressure and a controller connected to said first pressure monitor, said second pressure monitor and said drain valve for operating said drain valve when said first water pressure measured by said first pressure monitor exceeds said second water pressure measured by said second pressure monitor by a predetermined value.

20. The cooling system of claim 19 wherein said predetermined value is at least about 5 psi.
